(19) United States
(12) Patent Application Publication
(10) Pub. No.: US 2026/0163968 A1
(43) Pub. Date: Jun. 11, 2026

(54) ELECTRONIC DEVICE INCLUDING CONNECTOR SOCKET

(71) Applicant: SAMSUNG ELECTRONICS CO., LTD., Suwon-si (KR)

(72) Inventors: Sujin CHO, Suwon-si (KR); Jinsang Kim, Suwon-si (KR); Jungwon Park, Suwon-si (KR); Jongik Won, Suwon-si (KR); Kiyoung Jung, Suwon-si (KR); Woosung Chung, Suwon-si (KR); Jeonghyeon Choi, Suwon-si (KR)

(73) Assignee: SAMSUNG ELECTRONICS CO., LTD., Suwon-si (KR)

(21) Appl. No.: 19/183,195

(22) Filed: Apr. 18, 2025

Related U.S. Application Data
(63) Continuation of application No. PCT/KR2025/004504, filed on Apr. 3, 2025.

(30) Foreign Application Priority Data
Jul. 3, 2024 (KR) 10-2024-0087562
Aug. 23, 2024 (KR) 10-2024-0113681

(51) Int. Cl. H04M 1/02; H01Q 1/24; H01Q 1/38

(52) U.S. Cl. CPC H04M 1/0274; H01Q 1/243; H01Q 1/38; H04M 1/0216; H04M 1/0277

(57) ABSTRACT

An electronic device includes: a housing including an exterior side wall including a conductive portion configured to function as an antenna radiator and including an opening, and a conductive ring electrically disconnected from the conductive portion of the exterior side wall and electrically connected to a ground of the electronic device, the conductive ring including a hole aligned with the opening of the exterior side wall; and a connector in the housing, the connector including a connection terminal at least partially positioned within the hole and spaced apart from the conductive ring, the connection terminal being configured to be electrically connected to a plug of an external connector inserted through the hole and the opening of the exterior side wall.

### CROSS-REFERENCE TO RELATED APPLICATIONS

This application is a continuation of International Application No. PCT/KR2025/004504, designating the United States, filed on Apr. 3, 2025, in the Korean Intellectual Property Receiving Office, and claiming priority to Korean Patent Application Nos. 10-2024-0087562 filed on Jul. 3, 2024, and 10-2024-0113681 filed on Aug. 23, 2024, in the Korean Intellectual Property Office, the disclosures of each of which are incorporated by reference herein in their entireties.

### BACKGROUND

### 1. Field

The present disclosure relates to an electronic device including a connector socket.

### 2. Description of Related Art

An electronic device may include an interface for connection with an external electronic device or an external storage device. The electronic device may include a connector connected to a connector of the external electronic device. The electronic device may be connected to an external electronic device or the external storage device. The electronic device may receive data from the external electronic device or the external storage device or the electronic device may transmit data to the external electronic device or the external storage device. To reduce noise, the interface may include a conductive cell surrounding a socket accommodating a plug.

The above-described information may be provided as related art for the purpose of helping to understand the present disclosure. No claim or determination is raised as to whether any of the above-described information may be applied as prior art related to the present disclosure.

### SUMMARY

According to an aspect of the disclosure, an electronic device includes: a housing including an exterior side wall including a conductive portion configured to function as an antenna radiator and including an opening, and a conductive ring electrically disconnected from the conductive portion of the exterior side wall and electrically connected to a ground of the electronic device. The conductive ring includes a hole aligned with the opening of the exterior side wall; and a connector in the housing, the connector including a connection terminal at least partially positioned within the hole and spaced apart from the conductive ring. The connection terminal is configured to be electrically connected to a plug of an external connector inserted through the hole and the opening of the exterior side wall.

According to an aspect of the disclosure, a foldable electronic device includes: a housing including a first housing part and a second housing part rotatably connected to the first housing part; and a connector in the first housing part. The first housing part includes: an exterior side wall including a plurality of conductive portions configured to function as an antenna, and an opening in a conductive portion of the plurality of conductive portions; a conductive ring electrically connected to a ground of the foldable electronic device and including a first hole aligned with the opening of the conductive portion; and a non-conductive portion between the conductive portion and the conductive ring, and including a second hole connecting the first hole and the opening. The connector includes a connection terminal that is at least partially positioned within the first hole and spaced apart from the conductive ring. The connection terminal is configured to be configured to be electrically connected to a plug of an external connector inserted through the first hole of the conductive ring, the second hole of the non-conductive portion, and the opening of the conductive portion.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an example of an unfolded state of a foldable electronic device according to an embodiment;

FIG. 1B illustrates an example of a folded state of a foldable electronic device according to an embodiment;

FIG. 1C is an exploded view of a foldable electronic device according to an embodiment;

FIG. 2 is a rear view of a foldable electronic device with a rear cover removed, according to an embodiment;

FIG. 3 is an enlarged view of a portion of a foldable electronic device in which a connector is disposed, according to an embodiment;

FIG. 4 is a cross-sectional view of a portion of a foldable electronic device in which a connector is disposed, according to an embodiment;

FIG. 5 illustrates a flexible printed circuit board connecting a connector to a printed circuit board, according to an embodiment;

FIG. 6 is a perspective view illustrating a conductive ring constituting a connector and a housing, according to an embodiment;

FIG. 7 illustrates a conductive ring in a housing of a foldable electronic device, according to an embodiment;

FIG. 8 illustrates a conductive ring and a connector in a housing of a foldable electronic device, according to an embodiment;

FIG. 9 illustrates a connector hole portion of a foldable electronic device according to an embodiment;

FIGS. 10 and 11 illustrate a conductive tape connecting a connector and a conductive ring, according to an embodiment;

FIGS. 12 and 13 illustrate a conductive ring connected to a bracket of a housing, according to an embodiment; and

FIG. 14 is a block diagram of an electronic device in a network environment according to various embodiments.

### DETAILED DESCRIPTION

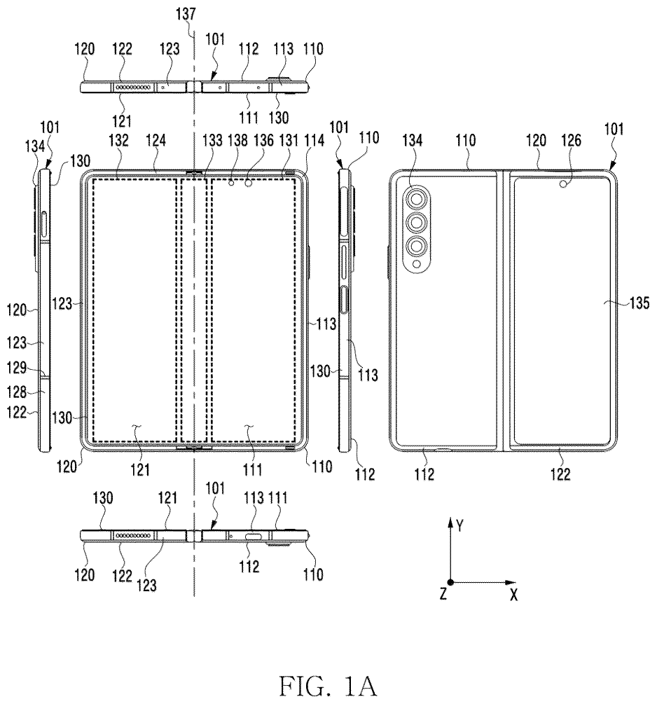

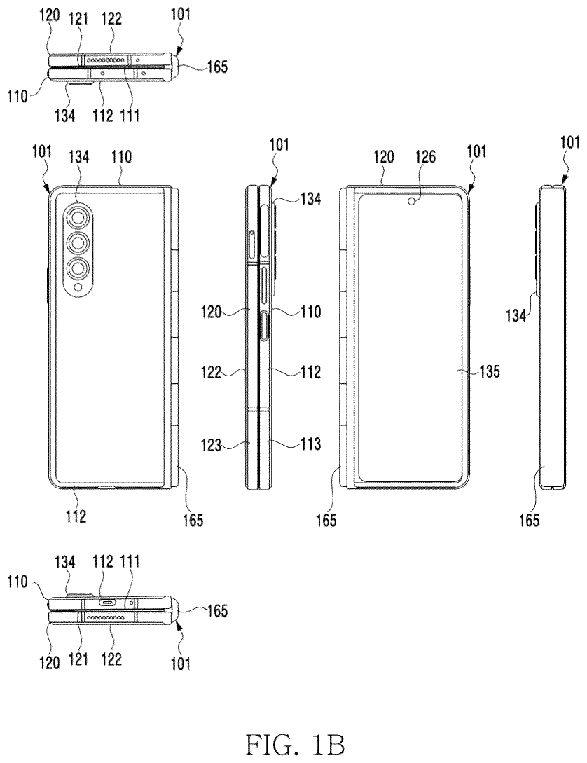

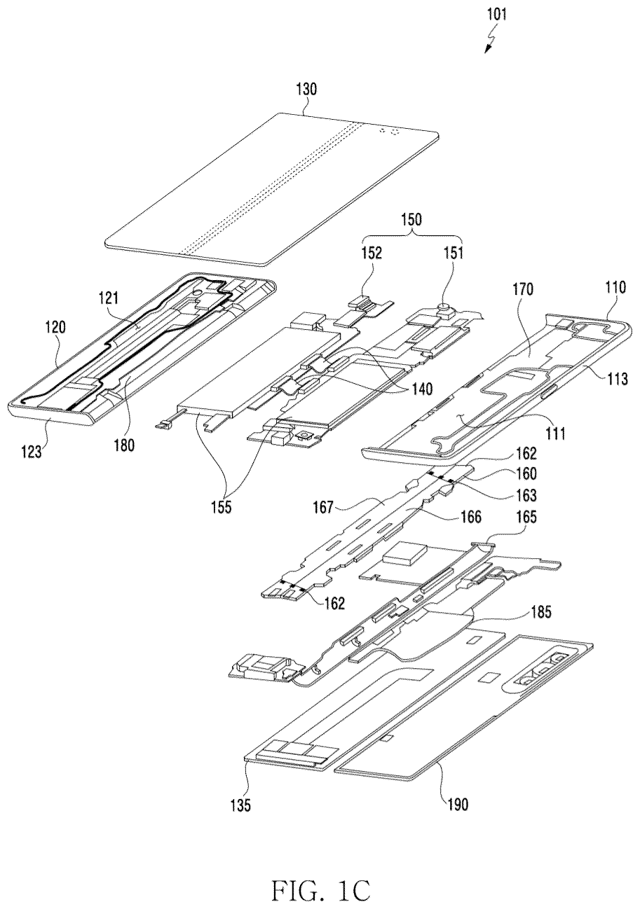

FIG. 1A illustrates an example of an unfolded state of a foldable electronic device according to an embodiment, FIG. 1B illustrates an example of a folded state of a foldable electronic device according to an embodiment, and FIG. 1C is an exploded view of a foldable electronic device according to an embodiment.

Referring to FIGS. 1A, 1B, and 1C, an electronic device 101 may include a first housing part 110, a second housing part 120, and a foldable display 130. The electronic device 101 may be referred to as a foldable electronic device, in that it is folded based on a folding axis 137.

The electronic device 101 may include a first housing part 110, a second housing part 120, a hinge structure 160, a foldable display 130, a printed circuit board 150, a display 135, and/or a rear plate 190. According to an embodiment, the electronic device 101 may omit at least one of the components or may additionally include another component.

In an embodiment, the first housing part 110 may define a portion of an outer surface of the electronic device 101. The first housing part 110 may define a first surface 111, a second surface 112 spaced apart from the first surface 111 and opposite to the first surface 111, and a first side surface of a first sidewall 113 surrounding at least a portion of the first surface 111 and the second surface 112. In an embodiment, the first housing part 110 may provide a space defined by the first surface 111, the second surface 112, and the first side surface as a space for arranging components of the electronic device 101.

In an embodiment, the second housing part 120 may include a third surface 121, a fourth surface 122 facing and spaced apart from the third surface 121, and a second sidewall 123 surrounding at least a portion of the third surface 121 and the fourth surface 122. The second housing part 120 may provide a space defined by the third surface 121, the fourth surface 122, and a second side surface of the second sidewall 123 as a space for arranging components of the electronic device 101.

In an embodiment, the second sidewall 123 may be rotatably (or pivotably) connected to the first sidewall 113, through the hinge structure 160 disposed on a hinge cover 165. The hinge structure 160 may include a hinge module and hinge plates 166 and 167. The hinge plates may include a first hinge plate 166 and a second hinge plate 167, the first hinge plate 166 may be connected to the first housing part 110, and the second hinge plate 167 may be connected to the second housing part 120.

In an embodiment, the foldable display 130 may include a window exposed toward the outside. The window may protect a surface of the foldable display 130, and may be formed of a transparent member to transmit visual information provided from the foldable display 130 to the outside. The window may include a glass material such as ‘ultra-thin glass’(UTG) or a polymer material such as polyimide (PI).

In an embodiment, the foldable display 130 may form (or may include) at least a portion of the first surface 111 of the first housing part 110 (e.g., a front surface of the first housing part 110) and the third surface 121 of the second housing part 120 (e.g., a front surface of the second housing part 120). The foldable display 130 may be disposed on the first surface 111 of the first housing part 110 and the third surface 121 of the second housing part 120 across the hinge structure 160 within the hinge cover 165. The foldable display 130 may be configured to be bent in a folded state of the electronic device 101 by the hinge structure 160. The foldable display 130 may include a first display area 131, a second display area 132, and a third display area 133. For example, the foldable display 130 may include the first display area 131 disposed on the first surface 111 of the first housing, the second display area 132 disposed on the third surface 121 of the second housing, and the third display area 133 between the first display area 131 and the second display area 132. The foldable display 130 may be supported by a first bracket 170 of the first housing part 110 and a second bracket 180 of the second housing part 120.

According to an embodiment, the foldable display 130 may include an opening formed in a portion of a screen display area, or a support member (e.g., a bracket) supporting the foldable display 130 may include a recess or an opening. The electronic device 101 may include at least one camera aligned with the recess or the opening. For example, the first display area 131 may further include at least one camera 136 capable of obtaining an image from the outside through a portion of the first display area 131. According to an embodiment, at least one camera 136 may be included in a rear surface of the foldable display 130 corresponding to the first display area 131 or the second display area 132 of the foldable display 130. For example, at least one camera 136 may be disposed under the foldable display 130 and may be covered by the foldable display 130. The at least one camera 136 may be an ‘under display camera’ (UDC). The UDC is not exposed to the outside because the UDC is covered by the foldable display 130. However, the foldable display 130 is not limited to the above example embodiment. For example, the foldable display 130 may include an opening exposing at least one camera 136 to the outside. In an embodiment, the camera 136 may obtain an image of an external environment and/or an external object through the opening.

In an embodiment, the fourth surface 122 of the second housing part 120 may further include at least one camera 134 and the display 135, which are exposed through a portion of the fourth surface 122.

In an embodiment, the hinge structure 160 may be configured to pivotally connect the first bracket 170 forming the first housing part 110 and the second bracket 180 forming the second housing part 120.

In an embodiment, the electronic device 101 may be one of a folded state, an unfolded state, and an intermediate state. In the folded state, the first surface 111 of the first housing part 110 and the third surface 121 of the second housing part 120 face each other. In the folded state, a direction toward which the first surface 111 faces and a direction toward which the third surface 121 faces may be opposite to each other. In the unfolded state, the first surface 111 of the first housing part 110 and the third surface 121 of the second housing part 120 are substantially continuous planes. In the unfolded state, the direction toward which the first surface 111 faces and the direction toward which the third surface 121 faces may be the same. The intermediate state may be one between the unfolded state and the folded state. In the intermediate state, the direction toward which the first surface 111 faces and the direction toward which the third surface 121 faces may be different from each other.

In an embodiment, while the electronic device 101 is in the folded state, the hinge cover 165 surrounding the hinge structure 160 may be at least partially exposed through a space between the first housing part 110 and the second housing part 120. In another embodiment, while the electronic device 101 is in the unfolded state, the hinge cover 165 may be surrounded by the first housing part 110 and the second housing part 120.

In an embodiment, the electronic device 101 may be folded based on the folding axis 137 passing through the hinge cover 165 or the hinge structure 160. For example, the hinge structure 160 within the hinge cover 165 may be positioned between the first housing part 110 and the second housing part 120 of the electronic device 101 so that the electronic device 101 may be bent, curved, or folded. For example, the first housing part 110 may be connected to the second housing part 120 through the hinge structure 160 positioned within the hinge cover 165, and may be rotated based on the folding axis 137.

In an embodiment, the electronic device 101 may be folded so that the first housing part 110 and the second housing part 120 face each other by rotating based on the folding axis 137. In an embodiment, the electronic device 101 may be folded so that the first housing part 110 and the second housing part 120 are overlapped with each other or stacked each other.

The hinge structure 160 may include a hinge module and hinge plates 166 and 167. The hinge module may include hinge gears 162 and 163 enabling the first housing part 110 and the second housing part 120 to be pivotable.

The first housing part 110 may include a first bracket 170, and the second housing part 120 may include a second bracket 180. The first bracket 170 may be partially surrounded by the first sidewall 113, and the second bracket 180 may be partially surrounded by the second sidewall 123. The first bracket 170 may be integrally formed with the first sidewall 113, and the second bracket 180 may be integrally formed with the second sidewall 123. According to an embodiment, the first bracket 170 may be formed separately from the first sidewall 113, and the second bracket 180 may be formed separately from the second sidewall 123. The first sidewall 113 and the second sidewall 123 may be formed of a metal material, a non-metal material, or a combination thereof. For example, the first sidewall 113 may include a conductive portion 118 and a non-conductive portion 119. The conductive portion 118 may be used as a radiator of an antenna.

A surface of the first bracket 170 may be coupled to the rear plate 190, and another surface of the first bracket 170 may be coupled to the foldable display 130. A surface of the second bracket 180 may be coupled to the display 135, and another surface of the second bracket 180 may be coupled to the foldable display 130.

The printed circuit board 150 and a battery may be disposed in a space between a surface formed by the first bracket 170 and the second bracket 180 and a surface formed by the display 135 and the rear plate 190. The printed circuit board 150 may be separated to be respectively disposed on the first bracket 170 of the first housing part 110 and the second bracket 180 of the second housing part 120. Components for implementing various functions of the electronic device 101 may be disposed on the printed circuit board 150.

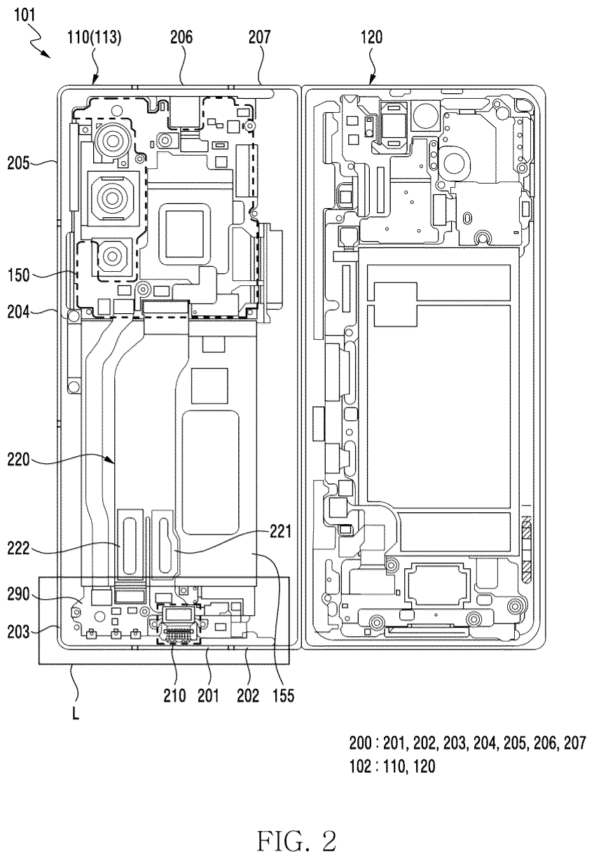

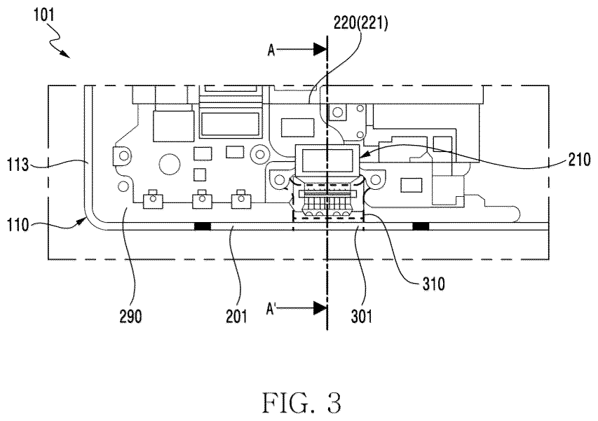

FIG. 2 is a rear view of a foldable electronic device with a rear cover removed, according to an embodiment. FIG. 3 is an enlarged view of a portion of a foldable electronic device in which a connector is disposed, according to an embodiment.

Referring to FIGS. 2 and 3, the electronic device 101 may include a housing 102 and a connector 210.

The housing 102 may include a first housing part 110 and a second housing part 120. The first housing part 110 may be rotatably coupled to the second housing part 120. For example, the first housing part 110 may include an exterior sidewall 200 (e.g., the first sidewall 113 of FIG. 1A) including conductive portions 201, 202, 203, 204, 205, 206, and 207. The conductive portions 201, 202, 203, 204, 205, 206, and 207 may be spaced apart from each other. For example, the second housing part 120 may include conductive portions corresponding to the first housing part 110.

At least one of the conductive portions 201, 202, 203, 204, 205, 206, and 207 disposed in the first housing part 110 may function as an antenna radiator. One conductive portion 201, which is disposed at a lower end among the conductive portions 201, 202, 203, 204, 205, 206, and 207 of the first housing part 110, may include an opening 301 for the connector 210. The electronic device 101, which is a foldable electronic device, may have a limited conductive portion capable of operating as an antenna due to a hinge structure. The conductive portion 201 among the conductive portions may operate as an antenna radiator. A shielding structure for the connector 210 connected to an external connector through an opening of the conductive portion 201 operating as an antenna radiator may be required.

The connector 210 may be fastened to another external connector inserted through the opening 301. The connector 210 disposed at the lower end of the first housing part 110 may be electrically connected to the printed circuit board 150 disposed at the upper end of the first housing part 110 through the flexible printed circuit board 220. At least one processor including a processing circuit disposed on the printed circuit board 150 may process data received from another external connector or load data from an external electronic device or an external storage device connected to the other connector through the other connector. The flexible printed circuit board 220 may extend from the printed circuit board 150 to the lower end of the first housing part 110. For example, the flexible printed circuit board 220 may extend from the printed circuit board 150 to another printed circuit board 290 across the battery 155 disposed in the first housing part 110. The other printed circuit board 290 may be disposed at the lower end of the first housing part 110. The battery 155 may be disposed between the printed circuit board 150 and the other printed circuit board 290. The printed circuit board 150 may be spaced apart from the other printed circuit board 290 by the battery 155.

According to an embodiment, the flexible printed circuit board 220 may extend from the printed circuit board 150 to the lower end of the first housing part 110 and may be divided into two branches. The flexible printed circuit board 220 may be divided into a first portion 221 in which the connector 210 is disposed and a second portion 222 connected to the other printed circuit board 290. The connector 210 connectable to the external connector may be disposed at an end of the first portion 221 of the flexible printed circuit board 220. The connector 210 is described as being disposed at the end of the first portion 221 of the flexible printed circuit board 220. The disclosure is not limited the above example embodiment. For example, the connector 210 may be disposed on the other printed circuit board 290.

According to an embodiment, at least a portion of the connector 210 may be surrounded by a conductive ring 310. The conductive ring 310 may be electrically disconnected from the conductive portion 201 functioning as an antenna radiator. The conductive ring 310 may be aligned with the opening 301 formed in the conductive portion 201.

The connector 210 may be connected with an external electronic device. For example, the connector 210 may be a universal serial bus (USB) connector or a C-type USB connector. According to an embodiment, the connector 210 may omit a cell surrounding a connection terminal.

As the cell surrounding the connection terminal of the connector 210 is omitted from the connector 210, a thickness of the electronic device 101 may be reduced by the thickness of the cell. The conductive ring 310 included in the first housing part 110 may at least partially surround the connection terminal of the connector 210. The conductive ring 310 may function as a cell by surrounding the connection terminal of the connector 210. For example, the conductive ring 310 may shield external noise flowing into the connection terminal of the connector 210. The conductive ring 310 may be connected to a conductive portion of the first housing part 110 operating as a ground to reduce noise flowing into the connection terminal of the connector 210. The conductive ring 310 may partially surround the connection terminal of the connector 210 to reduce noise transferred to the connection terminal of the connector 210 by a wireless communication signal transmitted and received through the conductive portion 201.

According to an embodiment, the conductive ring 310 may be integrally formed with a conductive portion and a non-conductive portion of the first housing part 110 as a configuration of the first housing part 110. For example, the conductive ring 310 may be integrally formed with the first housing part 110 by injection of the non-conductive portion of the first housing part 110. As the conductive ring 310 operates as a cell of the connector 210, the connector 210 may omit a cell. Since a thickness of the first housing part 110 may be reduced by the connector 210 in which the cell is omitted, and a thickness of the electronic device 101 may also be reduced.

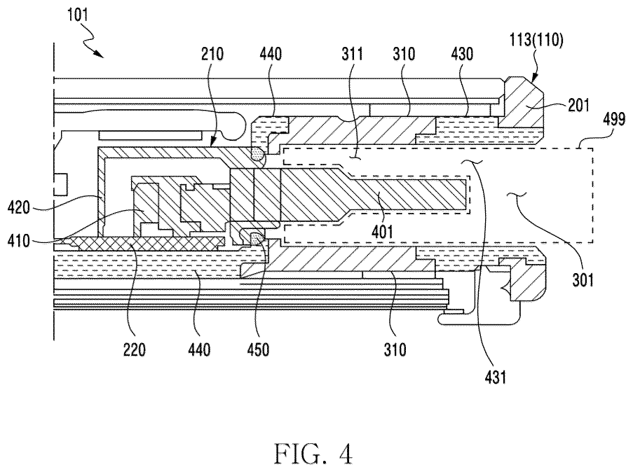

FIG. 4 is a cross-sectional view of a portion of a foldable electronic device in which a connector is disposed, according to an embodiment.

Referring to FIG. 4, a sidewall (e.g., the first sidewall 113 of FIG. 1A) of the first housing part 110 may include a conductive portion 201, a conductive ring 310, a first non-conductive portion 430, and a second non-conductive portion 440.

The conductive portion 201 may include the opening 301 that may pass through the first sidewall 113.

The first non-conductive portion 430 may be disposed between the conductive ring 310 and the conductive portion 201. The first non-conductive portion 430 may include a hole 431 extending from the opening 301. The first non-conductive portion 430 may separate the conductive portion 201 functioning as an antenna radiator from the conductive ring 310.

The conductive ring 310 may be disposed between the first non-conductive portion 430 and the second non-conductive portion 440. The conductive ring 310 may include a hole 311. The hole 311 of the conductive ring 310 may extend from the hole 431 of the first non-conductive portion 430. For example, the opening 301 of the conductive portion 201, the hole 311 of the conductive ring 310, and the hole 431 of the first non-conductive portion 430 may define a connector hole into which the external connector 499 may be inserted. The conductive ring 310 may be electrically disconnected from the conductive portion 201 operating as an antenna, and may be electrically connected to a ground of the electronic device 101. According to an embodiment, the conductive ring 310 may surround at least about 70% to 80% of an outer surface of the connection terminal 401 of the connector 210. The conductive ring 310 may surround the connection terminal 401 of the connector 210 and a plug of the external connector 499. The conductive ring 310 may induce coupling with the external connector 499 with respect to an alternating current signal (e.g., an RF signal), thereby reducing noise transferred to the connector 210 and the external connector 499.

For example, if the amount of overlap between the conductive ring 310, the connector 210, and the external connector 499 increases, a capacitance value between the connector 210, and the external connector 499 may increase. According to the increased capacitance value, surfaces formed of a conductive material may be coupled with respect to the RF signal. In order to increase the overlapping amount, the conductive ring 310 may be disposed adjacent to a conductive case 420 of the connector 210. According to an embodiment, in order to secure capacitance, an overlapping portion of the conductive ring 310 and the connection terminal 401 may be approximately 70% or more of the connection terminal 401 or a connection terminal (or a plug) of the external connector 499. According to an embodiment, the overlapping portion between the conductive ring 310 and the connection terminal 401 of the connector 210 may be limited to approximately 80% or less, in order to maintain a certain distance of the conductive portion 201 operating as an antenna.

According to an embodiment, the conductive ring 310 may further include an insulation film at an inner surface of the hole 311 in contact with the plug of the external connector 499. The insulation film may limit the conductive ring 310 from being electrically connected to the plug. When the conductive ring 310 is electrically connected to the plug, a surface of the conductive ring 310 may be corroded. For example, when the conductive ring 310 and the plug of the external connector 499 are in direct contact, corrosion may occur due to a leakage current. The insulation film may limit a physical contact between the conductive ring 310 and the plug of the external connector 499. For example, the insulation film may be generated by anodizing the inner surface of the hole 311 of the conductive ring 310.

According to an embodiment, the conductive ring 310 may extend into the electronic device to minimize a distance between the external connector 499 and a metal portion (e.g., the case 420) of the connector 210 or between an end of the external connector 499 and a metal part (e.g., a bracket or a support part in the housing) in the housing while the external connector 499 is coupled to the connector 210. The connector 210 may further include a sealing member 450 having a ring shape. The sealing member 450 may be configured to isolate the hole 311 of the conductive ring 310 connected through the connector hole from the inside of the electronic device 101. The sealing member 450 may be compressed by an end 441 of the second non-conductive portion 440 and the conductive case 420 of the connector 210. The sealing member 450 may be in contact with the second non-conductive portion 440 and the connector 210.

For example, the sealing member 450 may be disposed between the conductive case 420 and the second non-conductive portion 440 of the connector 210. The sealing member 450 may include an O-ring. Although the sealing member 450 has been described as a configuration of the connector 210, the sealing member 450 may include an adhesive, a tape, or a sealing material disposed between the connector 210 and the second non-conductive portion 440. When the sealing member 450 is in direct contact with the conductive ring 310, the sealing member 450 may be torn by a sharp metal surface. As an example, the second non-conductive portion 440 may be disposed between the conductive ring 310 and the sealing member 450 to reduce damage to the sealing member 450. The second non-conductive portion 440 may include a non-conductive material. The second non-conductive portion 440 may be referred to as a protective member in terms of protecting the sealing member 450. The second non-conductive portion 440 may include a polymer material. The second non-conductive portion 440 may be formed of the same material as the first non-conductive portion 430. For example, the second non-conductive portion 440 may be injected together with the first non-conductive portion 430 and coupled to the conductive portion 201 and the conductive ring 310 of the first housing part 110.

According to an embodiment, the sealing member 450 may include a conductive material. The sealing member 450 including the conductive material may reduce an interval due to a non-conductive portion between the conductive case 420 and the conductive ring 310. The sealing member 450 including the conductive material may reduce noise transferred to the connector 210 by reducing the interval between the conductive case 420 and the conductive ring 310. For example, the sealing member 450 may include a conductive tape, a conductive adhesive, or an O-ring including conductive grains.

The connector 210 may further include the conductive case 420. The connector 210 may include a connection portion 410 connected to the flexible printed circuit board 220. The conductive case 420 may surround the connection portion 410 of the connector 210. The connection portion 410 may be connected to a wiring in the flexible printed circuit board 220. The conductive case 420 may be electrically connected to a ground of the electronic device 101. For example, the conductive case 420 may be connected to a conductive portion included in a bracket (e.g., the bracket 170 of FIG. 1B) in the first housing part 110. The conductive case 420 may shield external noise transferred to the connection portion 410.

According to the above-described embodiment, the electronic device may reduce the thickness of the electronic device by omitting a cell surrounding the connection terminal 401. The noise transferred from the outside to the connection terminal 401 of the connector 210 may be reduced by implementing the cell surrounding the connection terminal 401 through the conductive ring 310, which is a conductive portion of the housing.

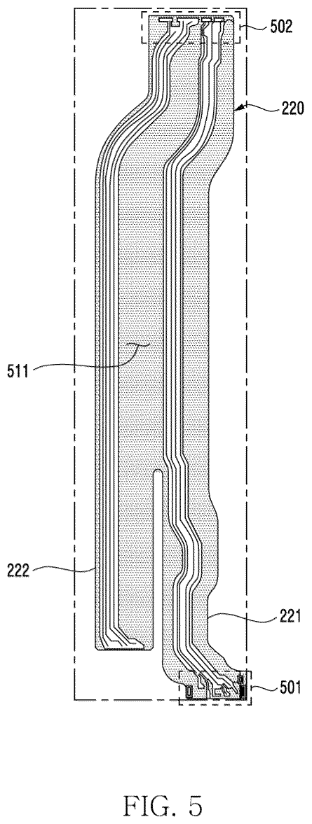

FIG. 5 illustrates a flexible printed circuit board connecting a connector to a printed circuit board, according to an embodiment.

Referring to FIG. 5, the connection portion 410 of the connector 210 may be connected to wirings included in the flexible printed circuit board 220. The conductive case 420 may be connected to a ground wiring. The connection portion 410 of the connector 210 may be mounted on an end 501 of the first portion 221 of the flexible printed circuit board 220. The connection portion 410 of the connector 210 may be attached to the end 501 of the first portion 221 of the flexible printed circuit board 220 through a surface mount technology (SMT).

The connection portion 410 of the connector 210 may be connected to a ground line 511 of the flexible printed circuit board 220 to electrically connect the conductive case 420 to a ground of the electronic device 101. Through the connection with the ground of the conductive case 420, external noise transferred to the connector 210 may be shielded.

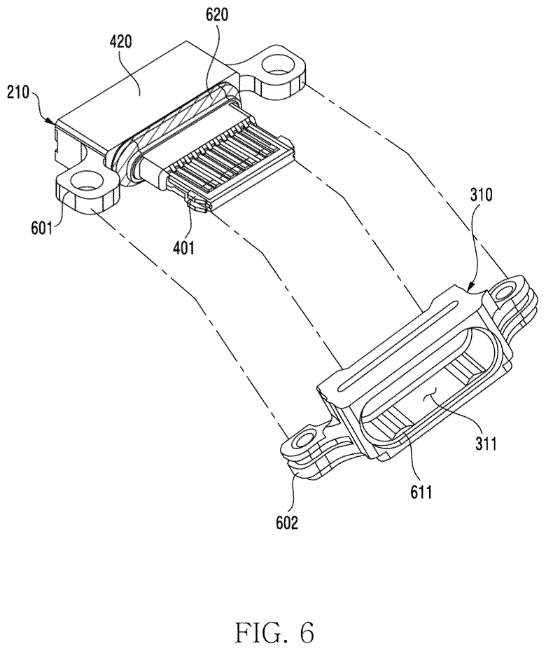

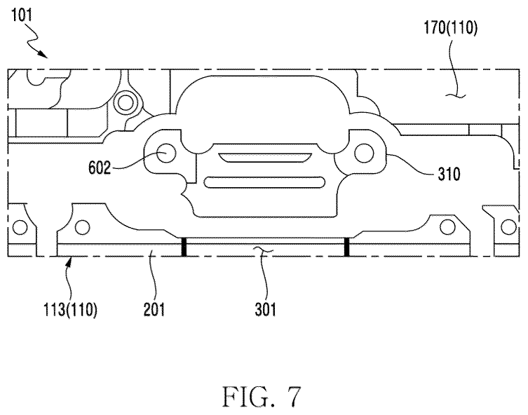

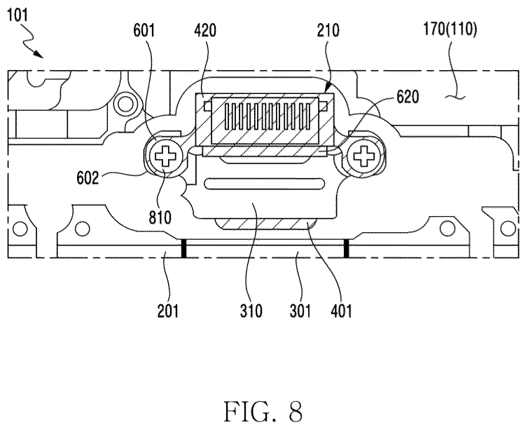

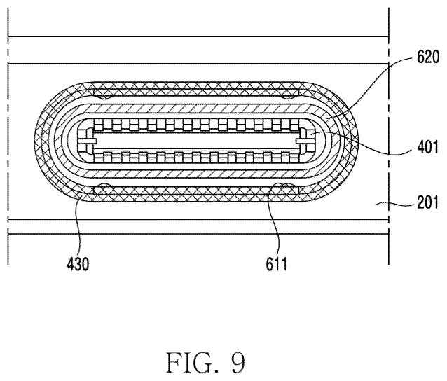

FIG. 6 is a perspective view illustrating a conductive ring constituting a connector and a housing, according to an embodiment. FIG. 7 illustrates a conductive ring in a housing of a foldable electronic device, according to an embodiment. FIG. 8 illustrates a conductive ring and a connector in a housing of a foldable electronic device, according to an embodiment. FIG. 9 illustrates a connector hole portion of a foldable electronic device according to an embodiment.

Referring to FIGS. 6, 7, 8, and 9, a connector 210 may include a connection terminal 401 and a conductive case 420. The connection terminal 401 may be engaged with a plug of an external connector (e.g., the external connector 499 of FIG. 4). For example, when the external connector 499 is inserted into a connector hole in which the connector 210 of the electronic device 101 is disposed, the connection terminal 401 of the connector 210 may be fastened to the plug of the external connector 499. The connector 210 may transfer data or signals, received from the external connector 499 through the connection terminal 401, to an electronic component (e.g., processor or memory) in an electronic device through a flexible printed circuit board (e.g., flexible printed circuit board 220 of FIG. 2), or may transfer data or signals from the electronic component to the external connector 499. The conductive case 420 may be further included to shield noise transferred to the connector 210 while the data or signal is transferred through the connector 210. The conductive case 420 may surround a connection portion (e.g., the connection portion 410 of FIG. 4) connecting the connection terminal 401 of the connector 210 and the flexible printed circuit board 220. The conductive case 420 may be electrically connected to the ground of the electronic device.

The conductive ring 310 may include a hole 311 into which the connection terminal 401 is inserted. The conductive ring 310 may be disposed to surround the connection terminal 401. The conductive ring 310 may be connected to the conductive case 420 of the connector 210. The conductive ring 310 may be electrically connected to the ground of the electronic device 101. The conductive ring 310 may surround a connection terminal of the connector 210 and a plug of the external connector 499 while the plug of the external connector 499 engaged with the connector 210 is inserted into the hole 311. The conductive ring 310 may shield noise transferred to the external connector 499 and the connector 210.

Referring to FIGS. 6 and 8, the conductive ring 310 and the connector 210 may be aligned with the opening 301 that opens the conductive portion 201. The opening 301 may be included in a portion of the connector hole. The conductive ring 310 adjacent to the conductive portion 201 operating as an antenna radiator may reduce noise transferred to the connector 210 by the conductive portion 201, while the conductive portion 201 operates as an antenna radiator.

Referring to FIG. 6, the conductive ring 310 may be coupled to the connector 210. The connector 210 may include a first fasten structure 601 for coupling with the conductive ring 310. The conductive ring 310 may include a second fasten structure 602 for coupling with the connector 210. The first fasten structure 601 and the second fasten structure 602 may include a conductive material. The first fasten structure 601 may protrude from the outside of the conductive case 420 of the connector 210. The second fasten structure 602 may protrude from an outer surface of the conductive ring 310. The first fasten structure 601 and the second fasten structure 602 may have positions and shapes corresponding to each other. The first fasten structure 601 and the second fasten structure 602 may include a fastening hole for coupling to each other. The fastening hole may include a thread formed at an inner surface. The conductive ring 310 may be connected to the conductive case 420 of the connector 210 electrically connected to the ground of the electronic device, through the first fasten structure 601 and the second fasten structure 602.

Referring to FIG. 7, the conductive ring 310 may be disposed together with conductive portions of the first housing part 110. The non-conductive portions are injected, so that the conductive ring 310 may be substantially integrally coupled to the bracket 170 of the first housing part 110 and the conductive portion 201. The conductive ring 310 (or the hole 311 of the conductive ring 310) may be aligned with the opening 301 of the conductive portion 201.

Referring to FIG. 8, the connection terminal 401 of the connector 210 may be inserted into the hole 311 of the conductive ring 310. The first fasten structure 601 and the second fasten structure 602 of the connector 210 may be disposed to overlap each other. The conductive ring 310 may be fastened to the conductive case 420 of the connector 210 through a screw 810 penetrating holes of the first fasten structure 601 and the second fasten structure 602 of the connector 210. The conductive ring 310 fastened to the conductive case 420 may be electrically connected to a conductive portion of the bracket 170 of the first housing part 110 operating as a ground of the electronic device 101.

Referring to FIGS. 6 and 9, the connector 210 may include a sealing member (e.g., the sealing member 450 of FIG. 4). For example, the sealing member 450 may include an O-ring 620 disposed between the connection terminal 401 of the connector 210 and the conductive case 420. The O-ring 620 may be disposed between the conductive case 420 and a second non-conductive portion (e.g., the second non-conductive portion 440 of FIG. 4) as illustrated in FIG. 4 to isolate the inside of the electronic device 101 from the connector hole connected to the hole 311. The O-ring 620 may restrict foreign matter or moisture flowing through the hole 311 from flowing into the electronic device 101.

According to an embodiment, the conductive ring 310 may include a protrusion 611 that guides a position of the external connector 499 and that protrudes from the inner surface of the hole 311. The protrusion 611 may protrude from the inner surface of the conductive ring 310. The protrusion 611 may guide a position of a plug of the external connector 499, and restrict the flow of the external connector 499 while the external connector 499 is connected to the connector 210. For example, the protrusion 611 may guide movement of the external connector 499 when the external connector 499 is inserted into the hole 311 for connection with the connection terminal 401. As the protrusion 611 restricts the flow of the coupled external connector 499, the external connector 499 may stably maintain the coupling with the connector 210.

According to an embodiment, the conductive ring 310 may be electrically connected to the conductive case 420 of the connector 210 connected to the external connector 499, in order to shield noise induced from the outside. The conductive ring 310 is connected to the conductive case 420 through the screw 810, but for stable shielding, the conductive ring 310 may be additionally connected to the conductive case 420 at other parts. The conductive ring 310 may be connected to another conductive portion in the electronic device 101 to improve shielding performance.

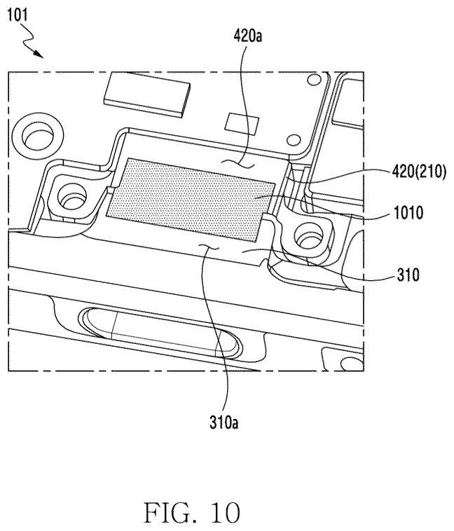

A structure for improving the shielding performance of the conductive ring 310 will be described with reference to FIGS. 10, 11, 12, and 13.

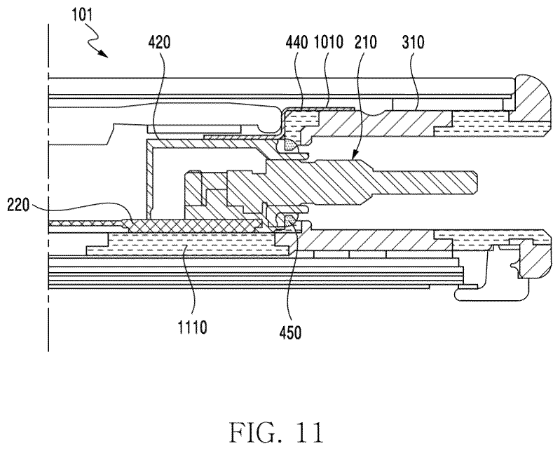

FIGS. 10 and 11 illustrate a conductive tape connecting a connector and a conductive ring, according to an embodiment.

Referring to FIGS. 10 and 11, the electronic device 101 according to an embodiment may further include a conductive material. For example, the electronic device 101 may further include a conductive tape 1010. The conductive tape 1010 may be attached to an outer surface 420a of the conductive case 420 of the connector 210 and a surface 310a of the conductive ring 310. The conductive tape 1010 may shield noise that may be transferred through a gap between the conductive ring 310 and the conductive case 420. The conductive tape 1010 may improve noise shielding performance and enhance the ground by electrically connecting the conductive ring 310 to the conductive case 420 connected to the ground.

In order to narrow the gap between the conductive ring 310 and the conductive case 420 to shield noise transferred through the gap between the conductive ring 310 and the conductive case 420, a portion of the second non-conductive portion 440 adjacent to the sealing member 450 may further include a conductive material such as metal.

According to an embodiment, the electronic device 101 may further include a conductive member 1110 disposed under the flexible printed circuit board 220. The conductive member 1110 may be electrically connected to the conductive ring 310, by being disposed to contact the conductive ring 310. The conductive member 1110 may be disposed under the flexible printed circuit board 220 to be electrically connected to a ground of the flexible printed circuit board 220. As an example, the conductive member 1110 may be or may correspond to a portion of the first bracket 170 of the first housing part 110. The conductive member 1110 may be configured to shield noise transferred from below the flexible printed circuit board 220.

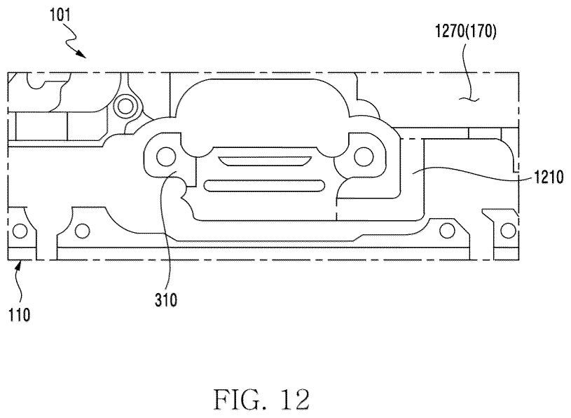

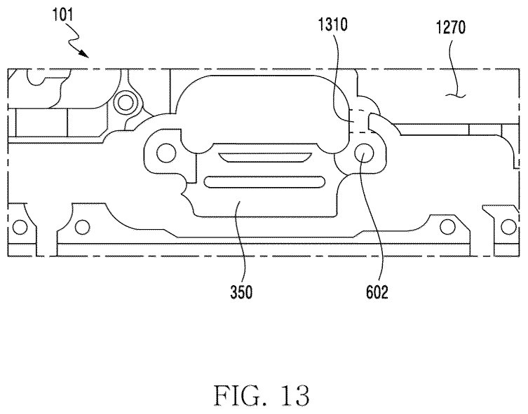

FIGS. 12 and 13 illustrate a conductive ring connected to a bracket of a housing, according to an embodiment.

Referring to FIGS. 12 and 13, the conductive ring 310 may include bridges 1210 and 1310 for providing electrical connection with a conductive portion 1270 in the first housing part 110. For example, the conductive portion 1270 may be included in the first bracket 170.

According to an embodiment, the conductive ring 310 may include a bridge 1210 extending from an outer surface of the conductive ring 310 to the conductive portion 1270 of the first housing part 110. The bridge 1210 may include a conductive material. When the conductive ring 310 is directly connected to the conductive portion 1270, a fasten structure (e.g., the second fasten structure 602 of FIG. 6) into which a screw is inserted may be separated from the conductive ring 310. However, the disclosure is not limited to the above example embodiment.

According to an embodiment, the conductive ring 310 may further include a bridge 1310 extending from the second fasten structure 602 to the conductive portion 1270. The conductive case 420 coupled through the second fasten structure 602 may also be electrically connected to the conductive portion 1270 of the first housing part 110 through the bridge 1310.

Through the above-described bridges 1210 and 1310, the conductive ring 310 may be electrically connected to the conductive portion 1270 of the first housing part 110 functioning as a ground of the electronic device 101. Shielding performance of the conductive ring 310 may be improved through the bridges 1210 and 1310, and the conductive tape 1010 of FIGS. 10 and 11.

According to the above-described embodiment, the electronic device may reduce the thickness of the electronic device by providing the connector in which a cell surrounding a connection terminal is omitted. The electronic device may improve ground performance by electrically connecting the connector and the conductive portion in the housing. The electronic device may reduce noise from an antenna radiator for wireless communication by surrounding the external connector inserted into the connector and the connector with a conductive ring. The shielding performance may be improved by increasing the overlapping amount between the conductive ring and the connector.

The technical problems to be achieved in this document are not limited to those described above, and other technical problems not mentioned herein will be clearly understood by those having ordinary knowledge in the art to which the present disclosure belongs, from the following description.

According to the above-described embodiment, an electronic device (e.g., the electronic device 101 of FIG. 4) may include a housing (e.g., the first housing part 110 of FIG. 4) and a connector (e.g., the connector 210 of FIG. 4) in the housing. The housing may include an exterior side wall (e.g., the first sidewall 113 of FIG. 4) and a conductive ring (e.g., the conductive ring 310 of FIG. 4). The exterior side wall may include a conductive portion functioning as an antenna radiator and including an opening. The conductive ring may be electrically disconnected from the conductive portion of the exterior side wall and may include a hole (e.g., the hole 311 of FIG. 4) aligned with the opening of the exterior side wall. The connector may include a connection terminal (e.g., the connection terminal 401), at least partially positioned within the hole, spaced apart from the conductive ring, configured to be electrically connected to a plug of an external connector (e.g., the external connector 499 of FIG. 4) inserted through the hole and the opening (e.g., the opening 301 of FIG. 4) of the exterior side wall into the housing. The conductive ring may be electrically connected to a ground of the electronic device.

According to the above-described embodiment, the electronic device may reduce the thickness of the electronic device by omitting a cell surrounding the connection terminal 401. The noise transferred from the outside to the connection terminal 401 of the connector 210 may be reduced by implementing the cell surrounding the connection terminal 401 through the conductive ring 310, which is a conductive portion of the housing.

According to an embodiment, the housing may further include a non-conductive portion (e.g., the first non-conductive portion 430 of FIG. 4) disposed between the conductive portion and the conductive ring. The non-conductive portion may include another hole (e.g., the hole 431 of FIG. 4) connecting the hole extending from the opening of the exterior side wall and the opening.

According to the above-described embodiment, the non-conductive portion 430 may separate the conductive portion 201 from the conductive ring 310 to reduce influence of the conductive portion 201 operating as an antenna.

According to an embodiment, the conductive ring may partially surround the connection terminal to reduce noise of the connector by a wireless communication signal transmitted and received through the conductive portion.

According to the above-described embodiment, the conductive ring may reduce the influence of the conductive portion 201 operating as an antenna by surrounding a connection portion of the connector.

According to an embodiment, the electronic device may further include a printed circuit board (e.g., the printed circuit board 150 of FIG. 2) disposed in the housing and a flexible printed circuit board (e.g., the flexible printed circuit board 220 of FIG. 2) extending from the printed circuit board to the connector to connect the printed circuit board and the external connector.

According to an embodiment, the connector may include a conductive case (e.g., the conductive case 420 of FIG. 4) surrounding a connection portion (e.g., the connection portion 410 of FIG. 4) of the connector connected to the flexible printed circuit board. The connection portion may be connected to wirings of the flexible printed circuit board extending to the printed circuit board, and the conductive case may be connected to a ground wiring among the wirings.

According to an embodiment, the electronic device may include a protective member (e.g., the second non-conductive portion 440 of FIG. 4) including a polymer and disposed between the conductive ring and the connector, and a sealing member (e.g., the sealing member 450 of FIG. 4) having a ring shape, contacting with the protective member and the connector to isolate the inside of the electronic device and the hole.

According to the above-described embodiment, the sealing member may prevent moisture or foreign substances from flowing into the electronic device through the connector hole. In order to prevent damage to the sealing member, the sealing member may be in contact with a second non-conductive portion coupled to the conductive ring.

According to an embodiment, the sealing member may include a conductive material.

According to the above-described embodiment, as the sealing member includes a conductive material, noise capable of flowing in through a gap by the second non-conductive portion may be reduced.

According to an embodiment, the conductive ring may include a conductive bridge (e.g., the bridge 1210 of FIG. 12 and/or the bridge 1310 of FIG. 13) connected to the conductive portion of the housing.

Through the conductive bridge, the conductive ring may be connected to a conductive portion of the housing operating as a ground. The ground of the conductive ring connected to the conductive bridge may be enhanced.

According to an embodiment, the conductive ring may include a conductive fasten structure (e.g., the second fasten structure 602 of FIG. 6) for connection with the conductive case of the connector.

According to an embodiment, the conductive ring may include a conductive bridge (e.g., the bridge 1310 in FIG. 13) connecting the conductive portion of the housing and the conductive fasten structure.

According to an embodiment, the foldable electronic device may further include a conductive tape (e.g., the conductive tape 1010 of FIG. 10) attached to an outer surface (a first surface) of the conductive case of the connector and a surface (a second surface) of the conductive ring.

According to the above-described embodiment, the conductive tape may cover a gap between the conductive ring and the conductive case, and noise transferred from the outside may be reduced by covering the gap.

According to an embodiment, the conductive ring may include a protrusion (e.g., the protrusion 611 of FIG. 6) that guides a position of the external connector and that protrudes from an inner surface of the hole.

According to the above-described embodiment, the protrusion may guide a position of the external connector, and the protrusion may prevent the flow of the external connector.

According to an embodiment, the conductive ring may surround 70% to 80% of the connection terminal.

According to the above-described embodiment, the conductive ring may surround the connection terminal in order to secure a sufficient capacitance with the conductive portion of the plug of the external connector. Through the secured capacitance, the conductive portion of the plug and the conductive ring may be coupled with respect to a high-frequency signal.

In order to be spaced apart from the conductive portion operating as an antenna so as not to be coupled, the conductive ring may not surround a portion of the connection terminal adjacent to the conductive portion.

According to an embodiment, the conductive ring may include an insulation film disposed on an inner surface of the hole in contact with a plug of the external connector.

According to the above-described embodiment, the conductive ring may prevent corrosion due to a current between the conductive ring and the plug by including the insulation film. Through the insulation film, the conductive ring and the plug, which are physically spaced apart from each other, may be coupled with respect to a high frequency signal.

According to an embodiment, the housing may include the conductive portion, a first housing part (e.g., the first housing part 110 of FIG. 1A) in which the connector is disposed, and a second housing part (e.g., the second housing part 120 of FIG. 1A) rotatably connected to the first housing part.

According to an embodiment, a foldable electronic device (e.g., the electronic device 101 of FIG. 1A) may include a housing (e.g., the housing 102 of FIG. 2). The housing may include a first housing part (e.g., the first housing part 110 of FIG. 1A) and a second housing part (e.g., the second housing part 120 of FIG. 1A) rotatably connected to the first housing part. The foldable electronic device may include a connector (e.g., the connector 210 of FIG. 4) in the first housing part. The first housing part may include an exterior side wall (e.g., the first sidewall 113 of FIG. 4).

The exterior side wall may include a plurality of conductive portions (e.g., the plurality of conductive portions 201, 202, 203, 204, 205, 206, and 207 of FIG. 2) functioning as an antenna radiator, and an opening (e.g., the opening 301 of FIG. 4) included in one (e.g., the conductive portion 201 of FIG. 4) of the plurality of conductive portions.

The first housing part may further include a conductive ring (e.g., the conductive ring 310). The conductive ring may include a first hole aligned with the opening of the conductive portion. The first housing part may further include a non-conductive portion (e.g., the first non-conductive portion 430 of FIG. 4). The non-conductive portion may be disposed between the one conductive portion and the conductive ring, and may include a second hole (e.g., the hole 311 of FIG. 4) connecting the first hole (e.g., the hole 431 of FIG. 4) and the opening. The connector may further include a connection terminal (e.g., the connection terminal 401 of FIG. 4). The connection terminal may be at least partially positioned within the hole, spaced apart from the conductive ring, and configured to be electrically connected to a plug of an external connector inserted into the housing through the first hole of the conductive ring, the second hole of the non-conductive portion, and the opening of the conductive portion.

According to the above-described embodiment, the electronic device may reduce the thickness of the electronic device by providing a connector in which a cell surrounding the connection terminal is omitted. The electronic device may improve ground performance by electrically connecting the connector and the conductive portion in the housing. The electronic device may reduce noise from an antenna radiator for a wireless communication by surrounding the external connector inserted into the connector and the connector with a conductive ring. The shielding performance may be improved by increasing the overlapping amount between the conductive ring and the connector.

According to an embodiment, the conductive ring may be electrically connected to the ground of the electronic device.

According to the above-described embodiment, the electronic device may reduce the thickness of the electronic device by omitting the cell surrounding the connection terminal 401. By implementing the cell surrounding the connection terminal 401 through the conductive ring 310, which is a conductive portion of the housing, noise transferred from the outside to the connection terminal 401 of the connector 210 may be reduced.

According to an embodiment, it may include a protective member including a polymer disposed between the conductive ring and the connector, and a sealing member, having a ring shape, contacting to the protective member and the connector to isolate an inside of the electronic device from the hole.

According to the above-described embodiment, the sealing member may prevent moisture or foreign substances from flowing into the electronic device through the connector hole. In order to prevent damage to the sealing member, the sealing member may be in contact with the second non-conductive portion coupled to the conductive ring.

According to an embodiment, the connector may include a conductive case (e.g., the conductive case 420 of FIG. 4) electrically connected to the ground of the electronic device. The connector may include a conductive tape (e.g., the conductive tape 1010 of FIG. 10) attached to the conductive case and the conductive ring.

According to the above-described embodiment, the conductive tape may cover a gap between the conductive ring and the conductive case, and noise transferred from the outside may be reduced by covering the gap.

According to an embodiment, the conductive ring may include a conductive fasten structure for connection with the conductive case of the connector.

According to an embodiment, the conductive portion may include a protrusion protruding from the inner surface of the first hole and guiding a position of the external connector.

According to the above-described embodiment, the protrusion may guide a position of the external connector, and the protrusion may prevent the flow of the external connector.

The effects that can be obtained from the present disclosure are not limited to those described above, and any other effects not mentioned herein will be clearly understood by those having ordinary knowledge in the art to which the present disclosure belongs, from the following description.

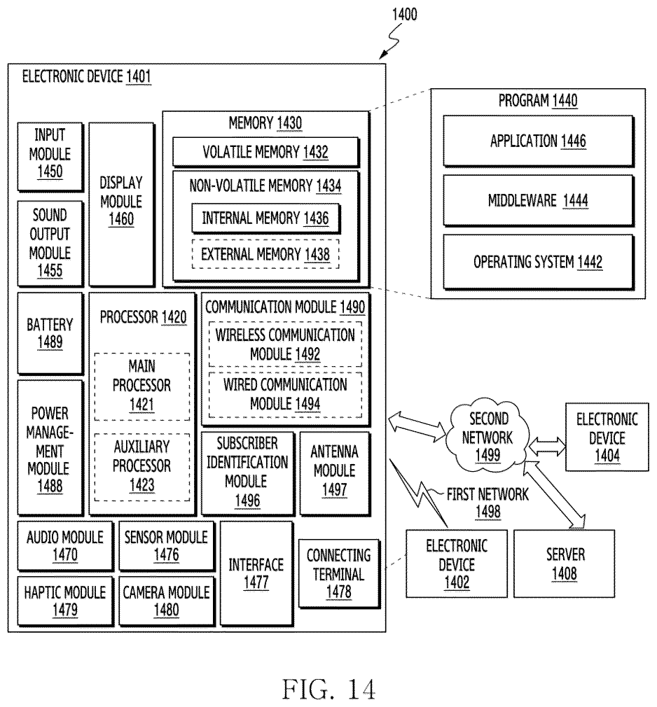

FIG. 14 illustrates an electronic device 1401 in a network environment 1400 according to various embodiments.

Referring to FIG. 14, the electronic device 1401 in the network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module(SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to an embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related to the software. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., through a wire or wires) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., through a wire or wires) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, an HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to an embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the mmWave band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 1464 dB or less) for implementing mMTC, or U-plane latency (e.g., 0.5 ms or less for each of downlink (DL) and uplink (UL), or a round trip of 14 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form (or may include) a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) between the above-described components via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra-low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through a wire or wires), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a housing comprising:
an exterior side wall comprising a conductive portion configured to function as an antenna radiator and comprising an opening, and
a conductive ring electrically disconnected from the conductive portion of the exterior side wall and electrically connected to a ground of the electronic device, the conductive ring comprising a hole aligned with the opening of the exterior side wall; and
a connector in the housing, the connector comprising a connection terminal at least partially positioned within the hole and spaced apart from the conductive ring, the connection terminal being configured to be electrically connected to a plug of an external connector inserted through the hole and the opening of the exterior side wall.

2. The electronic device of claim 1, wherein the housing further comprises a non-conductive portion between the conductive portion and the conductive ring, and
wherein the non-conductive portion further comprises another hole extending from the opening and connecting the hole and the opening.

3. The electronic device of claim 1, wherein the conductive ring partially surrounds the connection terminal to reduce noise at the connector from a wireless communication signal transferred through the conductive portion.

4. The electronic device of claim 1, further comprising:
a printed circuit board in the housing; and
a flexible printed circuit board extending from the printed circuit board to the connector to connect the printed circuit board and the external connector.

5. The electronic device of claim 4, wherein the connector comprises a conductive case surrounding a connection portion of the connector on the flexible printed circuit board,
wherein the connection portion is connected to wirings of the flexible printed circuit board, and
wherein the conductive case is connected to a ground wiring of the wirings.

6. The electronic device of claim 1, further comprising:
a protective member comprising a polymer and disposed between the conductive ring and the connector; and
a sealing member, having a ring shape, contacting to the protective member and the connector to isolate an inside of the electronic device and the hole.

7. The electronic device of claim 6, wherein the sealing member comprises a conductive material.

8. The electronic device of claim 1, wherein the conductive ring comprises a conductive bridge connected to the conductive portion of the housing.

9. The electronic device of claim 5, wherein the conductive ring comprises a conductive fasten structure to be connected to the conductive case of the connector.

10. The electronic device of claim 9, wherein the housing comprises a conductive bracket, and the conductive ring comprises a conductive bridge connecting the conductive bracket to the conductive fasten structure.

11. The electronic device of claim 5, further comprising a conductive tape attached to an outer surface of the conductive case of the connector and an outer surface of the conductive ring.

12. The electronic device of claim 1, wherein the conductive ring comprises a protrusion protruding from an inner surface of the hole and configured to guide a position of the external connector.

13. The electronic device of claim 1, wherein the conductive ring surrounds 70% to 80% of the connection terminal.

14. The electronic device of claim 1, wherein the conductive ring comprises an insulation film on an inner surface of the hole in contact with the plug of the external connector.

15. The electronic device of claim 1, wherein the housing further comprises:
a first housing part comprising the conductive portion and the conductive ring, wherein the connector is included in the first housing part; and
a second housing part rotatably connected to the first housing part.

16. A foldable electronic device comprising:
a housing comprising a first housing part and a second housing part rotatably connected to the first housing part; and
a connector in the first housing part;
wherein the first housing part comprises:
an exterior side wall comprising a plurality of conductive portions configured to function as an antenna, and an opening in a conductive portion of the plurality of conductive portions;
a conductive ring electrically connected to a ground of the foldable electronic device and comprising a first hole aligned with the opening of the conductive portion; and
a non-conductive portion between the conductive portion and the conductive ring, and comprising a second hole connecting the first hole and the opening, and
wherein the connector comprises a connection terminal that is at least partially positioned within the first hole and spaced apart from the conductive ring, the connection terminal being configured to be configured to be electrically connected to a plug of an external connector inserted through the first hole of the conductive ring, the second hole of the non-conductive portion, and the opening of the conductive portion.

17. The foldable electronic device of claim 16, further comprising:
a protective member between the conductive ring and the connector, and comprising a polymer; and
a sealing member having a ring shape and contacting to the protective member and the connector, the sealing member isolating an inside of the foldable electronic device from the first hole and the second hole.

18. The foldable electronic device of claim 16, wherein the connector comprises a conductive case electrically connected to the ground of the foldable electronic device, and
wherein the foldable electronic device comprises a conductive tape attached the conductive case and the conductive ring.

19. The foldable electronic device of claim 18, wherein the conductive ring further comprises a conductive fasten structure connected to the conductive case of the connector.

20. The foldable electronic device of claim 16, wherein the conductive portion comprises a protrusion protruding from an inner side of the first hole and configured to guide a position of the external connector.
